(19) United States
(12) Patent Application Publication
(10) Pub. No.: US 2012/0038855 A1
(43) Pub. Date: Feb. 16, 2012

(54) LIQUID CRYSTAL DISPLAY DEVICE

(75) Inventors: Yasutoshi Tasaka, Osaka (JP); Kaori Saitoh, Osaka (JP)

(73) Assignee: SHARP KABUSHIKI KAISHA, Osaka (JP)

(21) Appl. No.: 13/265,528

(22) PCT Filed: Apr. 22, 2010
(86) PCT No.: PCT/JP2010/002921

§ 371 Date: Oct. 20, 2011

(30) Foreign Application Priority Data
Apr. 24, 2009 (JP) 2009-106188

(51) Int. Cl. G02F 1/1335

(52) U.S. Cl. 349/96

(57) ABSTRACT

In a multi-domain-type liquid crystal display device including a vertically aligned liquid crystal layer, a drop in transmittance is suppressed when a pixel electrode having a fish-bone structure is used. The liquid crystal display device (100) according to the present invention is a liquid crystal display device which has a plurality of pixels and a pair of polarizing plates (50a and 50b) arranged in crossed Nicols and which performs display in normally black mode. Each of the plurality of pixels has a liquid crystal layer (40) containing liquid crystal molecules (41) having negative dielectric anisotropy, a pixel electrode (12) and an opposite electrode (22) that face each other via the liquid crystal layer (40), and a pair of vertical alignment films (32a and 32b) respectively provided between the pixel electrode (12) and the liquid crystal layer (40) and between the opposite electrode (22) and the liquid crystal layer (40). The pixel electrode (12) has a lower-layer conductive layer (13), a dielectric layer (14) that covers the lower-layer conductive layer (13), and an upper-layer conductive layer (15) provided on the dielectric layer (14) on the side of the liquid crystal layer (40). The upper-layer conductive layer (15) has a cross-shaped trunk portion (15a) arranged so as to overlap with the polarizing axes (P1 and P2) of the pair of polarizing plates (50a and 50b), a plurality of branch portions (15b) that extend in substantially 45° directions from the trunk portion (15a), and a plurality of slits (15c) formed between the plurality of branch portions (15b). The lower-layer conductive layer (13) is provided so as to face at least the plurality of slits (15c) via the dielectric layer (14).

### TECHNICAL FIELD

The present invention relates to a liquid crystal display device, and more particularly to a multi-domain-type liquid crystal display device including a vertically aligned liquid crystal layer.

### BACKGROUND ART

Currently, horizontal electric-field mode (including IPS mode and FFS mode) and vertically aligned mode (VA mode) are utilized as liquid crystal display devices having wide viewing-angle characteristics. The VA mode is superior to the horizontal electric-field mode in terms of mass productivity and is therefore widely utilized in TV applications and mobile applications. MVA mode is most widely used as the VA mode. The MVA mode is disclosed, for example, in Patent Document 1.

In the MVA mode, linear alignment control means (slits or ribs formed in an electrode) are arranged in two mutually orthogonal directions, and four liquid crystal domains are formed between the alignment control means. The angle of orientation of the director which represents each of the liquid crystal domains forms an angle of 45° with respect to the polarizing axes (transmission axes) of the polarizing plates arranged in crossed Nicols. If an angle of orientation of 0° is taken as the direction of the hour hand at 3 o'clock on the dial plate of a watch, and the counterclockwise direction is taken as the positive direction, then the angles of orientation of the directors of the four domains become 45°, 135°, 225°, and 315°. A structure in which four liquid crystal domains are formed in a single pixel in this manner is called a four-division alignment structure or simply a 4D structure.

The technology called “polymer sustained alignment technology” (also called PSA technology in some cases) has been developed for the purpose of improving the response characteristics of the MVA mode (see Patent Documents 2 and 3, for example). The PSA technology is such that after the liquid crystal cell is fabricated, an alignment sustaining layer (“polymer layer”) is formed by polymerizing, in a state in which a voltage is applied to the liquid crystal layer, a photopolymerizable monomer premixed into the liquid crystal material, and this is utilized to give the liquid crystal molecules a pretilt. By adjusting the distribution and intensity of the electric fields applied while the monomer is polymerized, it is possible to control the pretilt orientation (the angle of orientation within the substrate surface) and the pretilt angle (the angle of rise from the substrate surface) of the liquid crystal molecules.

Patent Document 3 also discloses the PSA technology together with a structure using a pixel electrode that has a fine striped pattern. With this structure, when a voltage is applied to the liquid crystal layer, the liquid crystal molecules are aligned parallel to the direction of length of the striped pattern. This is contrasting to the conventional MVA mode described in Patent Document 1 in which the liquid crystal molecules are aligned in directions orthogonal to the linear alignment control structures such as slits and ribs. The lines and spaces of a fine striped pattern (also called a “fish-bone structure” in some cases) may be narrower than the width of the conventional MVA-mode alignment control means. Accordingly, the fish-bone structure has an advantage over the conventional MVA-mode alignment control means in that it is more applicable to smaller pixels.

FIG. 4 shows a conventional liquid crystal display device 500 including a pixel electrode 512 having a fish-bone structure. As is shown in FIG. 4, the pixel electrode 512 of the liquid crystal display device 500 has a cross-shaped trunk portion 512a arranged so as to overlap with the polarizing axes P1 and P2 of a pair of polarizing plates arranged in crossed Nicols, a plurality of branch portions 512b that extend in substantially 45° directions from the trunk portion 512a, and a plurality of slits 512c formed between the plurality of branch portions 512b. The pixel electrode 512 is electrically connected to a TFT (not illustrated). The TFT is supplied with scan signals from scan wiring 516 and is supplied with image signals from signal wiring 517.

FIG. 5 is a diagram showing the fish-bone structure of the pixel electrode 512 and the relationship thereof to the orientation of the director of each liquid crystal domain. As is shown in FIG. 5, the trunk portion 512a of the pixel electrode 512 has a linear portion (horizontal linear portion) 512a1 extending in the horizontal direction and a linear portion (vertical linear portion) 512a2 extending in the vertical direction. The horizontal linear portion 512a1 and the vertical linear portion 512a2 cross (are orthogonal to) each other in the center of the pixel.

The plurality of branch portions 512b are divided into four groups corresponding to the four domains that are divided by the cross-shaped trunk portion 512a. The plurality of branch portions 512b are divided into a first group composed of the branch portions 512b1 extending in the direction of the 45° angle of orientation, a second group composed of the branch portions 512b2 extending in the direction of the 135° angle of orientation, a third group composed of the branch portions 512b3 extending in the direction of the 225° angle of orientation, and a fourth group composed of the branch portions 512b4 extending in the direction of the 315° angle of orientation.

Each of the plurality of slits 512c extends in the same direction as the adjacent branch portions 512b. In concrete terms, the slits 512c between the branch portions 512b1 of the first group extend in the direction of the 45° angle of orientation, and the slits 512c between the branch portions 512b2 of the second group extend in the direction of the 135° angle of orientation. Furthermore, the slits 512c between the branch portions 512b3 of the third group extend in the direction of the 225° angle of orientation, and the slits 512c between the branch portions 512b4 of the fourth group extend in the direction of the 315° angle of orientation.

At the time of the application of the voltage, the orientation of the tilt of the liquid crystal molecules (the orientation-angle component of the long axis of liquid crystal molecules inclined by the electric field) is defined by the oblique electric field generated in each of the slits (i.e., the portions of the pixel electrode 512 in which no conductive film is present) 512c. This orientation is parallel to the branch portions 512b (that is, parallel to the slits 512c) and in the direction toward the trunk portion 512a (that is, an orientation 180° different from the orientation of extension of the branch portions 512b). In concrete terms, the angle of orientation in the inclined orientation defined by the branch portions 512b1 of the first group (first orientation: arrow A) is approximately 225°, the angle of orientation in the inclined orientation defined by the branch portions 512b2 of the second group (second orientation: arrow B) is approximately 315°, the angle of orientation in the inclined orientation defined by the branch portions 512b3 of the third group (third orientation: arrow C) is approximately 45°, and the angle of orientation in the inclined orientation defined by the branch portions 512b4 of the fourth group (fourth orientation: arrow D) is approximately 135°. The aforementioned four orientations A to D become the orientations of the directors of the respective liquid crystal domains in the 4D structure formed at the time of the application of the voltage. Each of the orientations A to D is substantially parallel to some of the plurality of branch portions 512b, forming a substantially 45° angle with the polarizing axes P1 and P2 of the pair of polarizing plates. In addition, the difference in orientation between any two of the orientations A to D is substantially equal to an integral multiple of 90°, and the orientations of the directors of liquid crystal domains that are adjacent to each other via the trunk portion 512a (e.g., orientation A and orientation B) differ by substantially 90°.

As was described above, the liquid crystal molecules upon application of voltage are aligned in directions that form substantially 45° angles with the polarizing axes P1 and P2, i.e., in the directions of the angles of orientation at 45°, 135°, 225°, and 315°. Consequently, the 4D structure is formed in each pixel, and wide viewing-angle characteristics are obtained.

### RELATED ART DOCUMENTS

### Patent Documents

Patent Document 1: Japanese Patent Application Laid-Open Publication No. H11-242225

Patent Document 2: Japanese Patent Application Laid-Open Publication No. 2006-78968

Patent Document 3: Japanese Patent Application Laid-Open Publication No. 2007-286642

### SUMMARY OF THE INVENTION

### Problems to be Solved by the Invention

However, in a case in which the pixel electrode 512 having a fish-bone structure as described above is used, sufficient voltage cannot be applied to the liquid crystal layer in the areas corresponding to the slits 512c which are portions where no conductive film is present, thus resulting in a loss of transmittance (a drop in transmittance) upon application of voltage. Therefore, the effective aperture ratio of the pixel is reduced, and the display luminance ends up being reduced.

The present invention was devised in light of the aforementioned problems, and the object thereof is to suppress a drop in the transmittance in the case of using a pixel electrode having a fish-bone structure in a multi-domain-type liquid crystal display device including a vertically aligned liquid crystal layer.

### Means for Solving the Problems

The liquid crystal display device according to the present invention is a liquid crystal display device which has a plurality of pixels and a pair of polarizing plates arranged in crossed Nicols and which performs display in normally black mode, wherein each of the aforementioned plurality of pixels has a liquid crystal layer containing liquid crystal molecules having negative dielectric anisotropy, a pixel electrode and an opposite electrode that face each other via the aforementioned liquid crystal layer, and a pair of vertical alignment films respectively provided between the aforementioned pixel electrode and the aforementioned liquid crystal layer and between the aforementioned opposite electrode and the aforementioned liquid crystal layer, the aforementioned pixel electrode has a lower-layer conductive layer, a dielectric layer that covers the aforementioned lower-layer conductive layer, and an upper-layer conductive layer provided on the aforementioned dielectric layer on the side of the aforementioned liquid crystal layer, the aforementioned upper-layer conductive layer has a cross-shaped trunk portion arranged so as to overlap with the polarizing axes of the aforementioned pair of polarizing plates, a plurality of branch portions that extend in substantially 45° directions from the aforementioned trunk portion, and a plurality of slits formed between the aforementioned plurality of branch portions, and the aforementioned lower-layer conductive layer is provided so as to face at least the aforementioned plurality of slits via the aforementioned dielectric layer.

In a preferred embodiment, the aforementioned lower-layer conductive layer is electrically connected to the aforementioned upper-layer conductive layer.

In a preferred embodiment, the aforementioned lower-layer conductive layer is provided so as to face the aforementioned trunk portion and the aforementioned plurality of branch portions as well via the aforementioned dielectric layer.

In a preferred embodiment, when a voltage is applied across the aforementioned pixel electrode and the aforementioned opposite electrode, four liquid crystal domains are formed in the aforementioned liquid crystal layer within each of the aforementioned plurality of pixels, the orientations of the four directors representing the directions of alignment of the aforementioned liquid crystal molecules that are contained in each of the aforementioned four liquid crystal domains are different from each other, and each of the orientations of the aforementioned four directors forms an angle of substantially 45° with respect to the polarizing axes of the aforementioned pair of polarizing plates.

In a preferred embodiment, the aforementioned four liquid crystal domains are a first liquid crystal domain in which the orientation of the director is a first orientation, a second liquid crystal domain in which the orientation of the director is a second orientation, a third liquid crystal domain in which the orientation of the director is a third orientation, and a fourth liquid crystal domain in which the orientation of the director is a fourth orientation, with the aforementioned first orientation, second orientation, third orientation, and fourth orientation being such that the difference in orientation between any two of the orientations is substantially equal to an integral multiple of 90°, and the orientations of the directors of liquid crystal domains that are adjacent to each other via the aforementioned trunk portion differ by substantially 90°.

In a preferred embodiment, the liquid crystal display device according to the present invention additionally has a pair of alignment sustaining layers composed of a photopolymer and respectively formed on the surfaces of the aforementioned pair of vertical alignment films on the side of the aforementioned liquid crystal layer.

### Effects of the Invention

According to the present invention, in a multi-domain-type liquid crystal display device including a vertically aligned liquid crystal layer, a drop in transmittance is suppressed in the case of using a pixel electrode having a fish-bone structure.

### BRIEF DESCRIPTION OF THE DRAWINGS

FIGS. 1(a) and 1(b) are diagrams schematically showing the liquid crystal display device 100 in a preferred embodiment of the present invention; (a) is a plan view, and (b) is a sectional view along line 1B-1B′ in (a).

FIG. 2 is a plan view schematically showing the upper-layer conductive layer 15 of a pixel electrode 12 contained in the liquid crystal display device 100.

FIG. 3 is a plan view schematically showing the upper-layer conductive layer 15 of a pixel electrode 12 contained in the liquid crystal display device 100.

FIG. 4 is a plan view schematically showing a conventional liquid crystal display device 500 including a pixel electrode 512 that has a fish-bone structure.

FIG. 5 is a diagram showing the fish-bone structure of the pixel electrode 512 and the relationship thereof to the orientation of the director of each liquid crystal domain

### DETAILED DESCRIPTION OF EMBODIMENTS

An embodiment of the present invention will be described below while referring to the figures. Note that the present invention is not limited to the following embodiment.

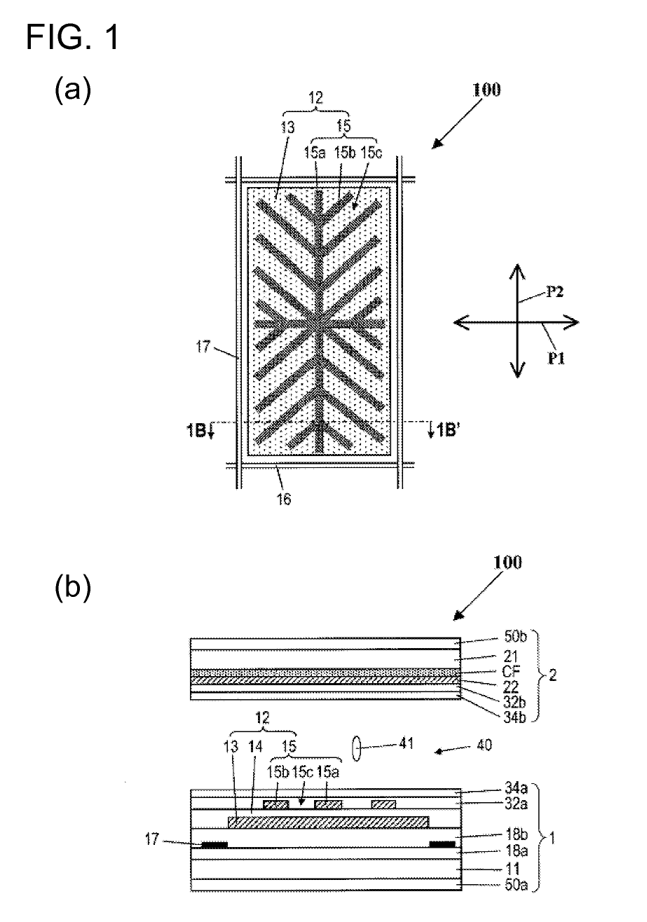

The liquid crystal display device 100 in the present embodiment is shown in FIGS. 1(a) and 1(b). FIG. 1(a) is a plan view schematically showing the liquid crystal display device 100, and FIG. 1(b) is a sectional view along line 1B-1B′ in FIG. 1(a).

The liquid crystal display device 100 is a liquid crystal display device which has a plurality of pixels and a pair of polarizing plates 50a and 50b arranged in crossed Nicols and which performs display in normally black mode.

Each of the plurality of pixels of the liquid crystal display device 100 has a liquid crystal layer 40 as well as a pixel electrode 12 and an opposite electrode 22 that face each other via the liquid crystal layer 40. The liquid crystal layer 40 contains liquid crystal molecules 41 having negative dielectric anisotropy. The pixel electrode 12 has a fish-bone structure (fine striped pattern) as will be described later.

A pair of vertical alignment films 32a and 32b are respectively provided between the pixel electrode 12 and the liquid crystal layer 40 and between the opposite electrode 22 and the liquid crystal layer 40. Furthermore, a pair of alignment sustaining layers 34a and 34b composed of a photopolymer are respectively formed on the surfaces of the vertical alignment films 32a and 32b on the side of the liquid crystal layer 40.

The alignment sustaining layers 34a and 34b are formed by polymerizing, in a state in which a voltage is applied to the liquid crystal layer 40, a photopolymerizable compound (typically a photopolymerizable monomer) premixed into the liquid crystal material following the formation of the liquid crystal cell. Until the photopolymerizable compound is polymerized, the alignment control of the liquid crystal molecules 41 contained in the liquid crystal layer 40 is performed by the vertical alignment films 32a and 32b. When a sufficiently high voltage (e.g., white display voltage) is applied to the liquid crystal layer 40, the liquid crystal molecules 41 tilt in a specified orientation by the oblique electric field generated by the fish-bone structure of the pixel electrode 12. The alignment sustaining layers 34a and 34b work so as to maintain (retain) the alignment of the liquid crystal molecules 41 with the voltage being applied to the liquid crystal layer 40 even after the voltage is removed (in a state in which no voltage is applied). Therefore, the pretilt orientation of the liquid crystal molecules 41 defined by the alignment sustaining layers 34a and 34b (the orientation of the tilt of the liquid crystal molecules 41 when no voltage is applied) matches the orientation of the tilt of the liquid crystal molecules 41 upon application of voltage. The alignment sustaining layers 34a and 34b can be formed by using the publicly known PSA technology (disclosed in Patent Documents 2 and 3, for example).

As is shown in FIG. 1(b), the liquid crystal display device 100 has an active matrix substrate (hereinafter referred to as “TFT substrate”) 1 containing pixel electrodes 12 and an opposite substrate (also referred to as “color filter substrate”) 2 containing an opposite electrode 22.

Besides the pixel electrodes 12, the TFT substrate 1 contains a transparent substrate (e.g., glass substrate or plastic substrate) 11, TFTs (not illustrated) electrically connected to the pixel electrodes 12, scan wiring 16 that supplies scan signals to the TFTs, and signal wiring 17 that supplies image signals to the TFTs.

The scan wiring 16 is formed on the surface of the transparent substrate 11 on the side of the liquid crystal layer 40. An insulating film 18a is formed so as to cover the scan wiring 16. The signal wiring 17 and a semiconductor layer (not illustrated) that functions as the channel regions, source regions, and drain regions of the TFTs are formed on the insulating film 18a. An insulating film 18b is formed so as to cover the signal wiring 17 and the like. The pixel electrodes 12 are provided on the insulating film 18b. Moreover, a polarizing plate 50a is provided on the transparent substrate 11 on the side opposite from the liquid crystal layer 40.

The opposite substrate 2 contains a transparent substrate (e.g., glass substrate or plastic substrate) 21 and a color filter CF besides the opposite electrode 22. The color filter CF is formed on the surface of the transparent substrate 21 on the side of the liquid crystal layer 40. The opposite electrode 22 is formed on the color filter CF. In addition, a polarizing plate 50b is provided on the transparent substrate 21 on the side opposite from the liquid crystal layer 40.

As was already mentioned, the pair of polarizing plates 50a and 50b are arranged in crossed Nicols. That is, the polarizing axis (transmission axis) P1 of one polarizing plate 50a and the polarizing axis (transmission axis) P2 of the other polarizing plate 50b are orthogonal to each other as shown in FIG. 1.

Each of the pixel electrodes 12 in the present embodiment has a lower-layer conductive layer (lower-layer electrode) 13, a dielectric layer (insulating film) 14 covering the lower-layer conductive layer 13, and an upper-layer conductive layer (upper-layer electrode) 15 provided on the dielectric layer 14 on the side of the liquid crystal layer 40. In the specification of the present application, the pixel electrode 12 that includes the lower-layer conductive layer 13 and the upper-layer conductive layer 15 may also be referred to as “two-layer structure electrode.” Note that the “lower-layer” and “upper-layer” are terms used to express the relative relationships of the two electrodes (conductive layers) 13 and 15 with respect to the dielectric layer 14 and are not something that limits the spatial arrangement during the use of the liquid crystal display device 100. Furthermore, the “two-layer structure electrode” does not exclude structures having electrodes (conductive layers) in addition to the lower-layer conductive layer 13 and the upper-layer conductive layer 15; any structure that has at least the lower-layer conductive layer 13 and the upper-layer conductive layer 15 and that exhibits the operations described below may be used.

The upper-layer conductive layer 15 has a cross-shaped trunk portion 15a arranged so as to overlap with the polarizing axes P1 and P2 of the pair of polarizing plates 50a and 50b, a plurality of branch portions 15b that extend in substantially 45° directions from the trunk portion 15a, and a plurality of slits 15c formed between the plurality of branch portions 15b. Thus, the upper-layer conductive layer 15 has a so-called fish-bone structure. The upper-layer conductive layer 15 is formed from a transparent conductive material (e.g., ITO).

The dielectric layer 14 is formed from a transparent dielectric material (e.g., transparent photosensitive resin).

The lower-layer conductive layer 13 is provided so as to face at least the plurality of slits 15c via the dielectric layer 14. In the present embodiment, the lower-layer conductive layer 13 is provided so as to face the trunk portion 15a and the plurality of branch portions 15b as well via the dielectric layer 14. That is, the lower-layer conductive layer 13 is a so-called plain electrode in which no slit or opening is formed. Moreover, the lower-layer conductive layer 13 is connected to the same TFT as the upper-layer conductive layer 15 and is thus electrically connected to the upper-layer conductive layer 15. Therefore, the lower-layer conductive layer 13 is supplied with the same potential that is supplied to the upper-layer conductive layer 15. The lower-layer conductive layer 13 is formed from a transparent conductive material (e.g., ITO).

In the liquid crystal display device 100, as a result of the upper-layer conductive layer 15 of each of the pixel electrodes 12 having a fish-bone structure (fine striped pattern) as described above, the alignment of each pixel is divided. Specifically, when a voltage is applied across the pixel electrode 12 and the opposite electrode 22, four (four types of) liquid crystal domains are formed in the liquid crystal layer 40 within each pixel. The orientations of the four directors representing the directions of alignment of the liquid crystal molecules 41 contained in each of the four liquid crystal domains are different from each other, so dependency of the viewing angle on the angle of orientation is reduced, thus realizing display in wide viewing angles.

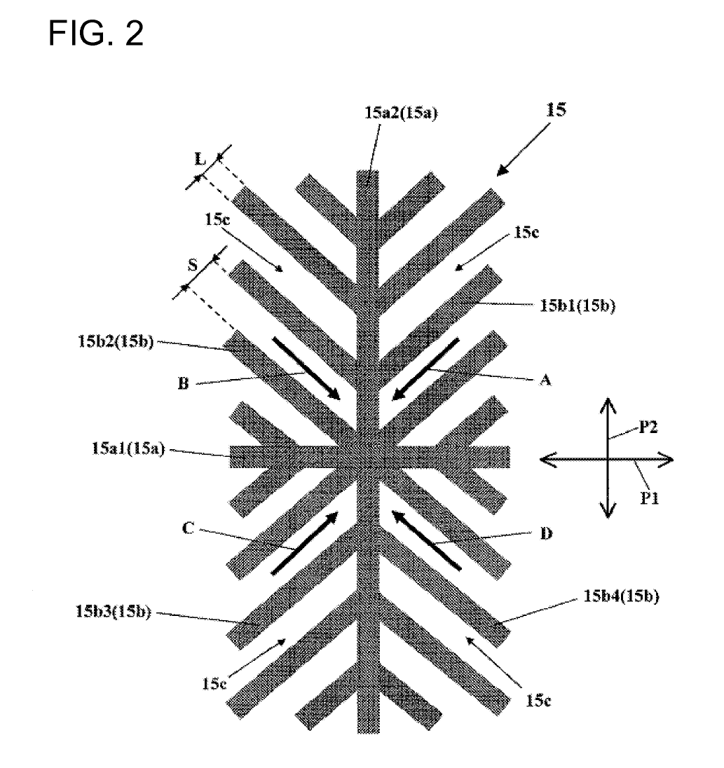

A more concrete structure of the upper-layer conductive layer 15 and the relationship thereof to the orientation of the director of each of the liquid crystal domains will be described below while referring to FIG. 2. FIG. 2 is a plan view showing only the upper-layer conductive layer 15 of a pixel electrode 12.

The trunk portion 15a of the upper-layer conductive layer 15 has a linear portion (horizontal linear portion) 15a1 extending in the horizontal direction and a linear portion (vertical linear portion) 15a2 extending in the vertical direction. The horizontal linear portion 15a1 and the vertical linear portion 15a2 cross (are orthogonal to) each other in the center of the pixel.

The plurality of branch portions 15b are divided into four groups corresponding to the four domains that are divided by the cross-shaped trunk portion 15a. If an angle of orientation of 0° is taken as the direction of the hour hand at 3 o'clock when the display surface is regarded as the dial plate of a watch, and the counterclockwise direction is taken as the positive direction, then the plurality of branch portions 15b are divided into a first group composed of the branch portions 15b1 extending in the direction of the 45° angle of orientation, a second group composed of the branch portions 15b2 extending in the direction of the 135° angle of orientation, a third group composed of the branch portions 15b3 extending in the direction of the 225° angle of orientation, and a fourth group composed of the branch portions 15b4 extending in the direction of the 315° angle of orientation.

In each of the first group, second group, third group, and the fourth group, the width L of each of the plurality of branch portions 15b and the space S between adjacent branch portions 15b are typically 1.5 μm to 5.0 μm. From the standpoint of the stability of the alignment of the liquid crystal molecules 41 and luminance, it is preferable that the width L and the space S of the branch portions 15b be within the aforementioned range. Note that the number of the branch portions 15b is not limited to the one exemplified in FIGS. 1 and 2.

Each of the plurality of slits 15c extends in the same direction as the adjacent branch portions 15b. In concrete terms, the slits 15c between the branch portions 15b1 of the first group extend in the direction of the 45° angle of orientation, and the slits 15c between the branch portions 15b2 of the second group extend in the direction of the 135° angle of orientation. Furthermore, the slits 15c between the branch portions 15b3 of the third group extend in the direction of the 225° angle of orientation, and the slits 15c between the branch portions 15b4 of the fourth group extend in the direction of the 315° angle of orientation.

At the time of the application of the voltage, the orientation of the tilt of the liquid crystal molecules 41 (the orientation-angle component of the long axis of the liquid crystal molecules 41 inclined by the electric field) is defined by the oblique electric field generated in each of the slits (i.e., the portions of the upper-layer conductive layer 15 in which no conductive film is present) 15c. This orientation is parallel to the branch portions 15b (that is, parallel to the slits 15c) and in the direction toward the trunk portion 15a (that is, an orientation 180° different from the orientation of extension of the branch portions 15b). In concrete terms, the angle of orientation in the inclined orientation defined by the branch portions 15b1 of the first group (first orientation: arrow A) is approximately 225°, the angle of orientation in the inclined orientation defined by the branch portions 15b2 of the second group (second orientation: arrow B) is approximately 315°, the angle of orientation in the inclined orientation defined by the branch portions 15b3 of the third group (third orientation: arrow C) is approximately 45°, and the angle of orientation in the inclined orientation defined by the branch portions 15b4 of the fourth group (fourth orientation: arrow D) is approximately 135°. The aforementioned four orientations A to D become the orientations of the directors of the respective liquid crystal domains in the 4D structure formed at the time of the application of the voltage. Each of the orientations A to D is substantially parallel to some of the plurality of branch portions 15b, forming a substantially 45° angle with the polarizing axes P1 and P2 of the pair of polarizing plates 50a and 50b. In addition, the difference in orientation between any two of the orientations A to D is substantially equal to an integral multiple of 90°, and the orientations of the directors of liquid crystal domains that are adjacent to each other via the trunk portion 15a (e.g., orientation A and orientation B) differ by substantially 90°.

In the liquid crystal display device 100 of the present embodiment, each of the pixel electrodes 12 is a two-layer structure electrode, and in addition to the upper-layer conductive layer 15 having a fish-bone structure, the lower-layer conductive layer 13 provided so as to face the plurality of slits 15c of the upper-layer conductive layer 15 is present. Therefore, sufficient voltage can also be applied to the areas of the liquid crystal layer 40 corresponding to the slits 15c, thus making it possible to contribute to the display. Accordingly, it is possible to suppress a drop in transmittance and to realize a bright display.

Note that the present embodiment exemplifies a structure in which the lower-layer conductive layer 13 is electrically connected to the upper-layer conductive layer 15, with the same potential being supplied to the lower-layer conductive layer 13 and the upper-layer conductive layer 15. However, the present invention is not limited to this; as long as the generation of the oblique electric fields in the slits 15c is not hindered, different potentials may also be supplied to the lower-layer conductive layer 13 and the upper-layer conductive layer 15. A structure in which the same potential is supplied to the lower-layer conductive layer 13 and the upper-layer conductive layer 15 as in the present embodiment can simply be realized by connecting the lower-layer conductive layer 13 and the upper-layer conductive layer 15 to the same TFT. In addition, there is also an advantage in that a conventional drive circuit can be used “as is.”

Furthermore, the present embodiment exemplifies the lower-layer conductive layer 13 that is a plain electrode (i.e., no patterning is performed), but it is sufficient if the lower-layer conductive layer 13 faces at least the plurality of slits 15c via the dielectric layer 14, and patterning may also be performed.

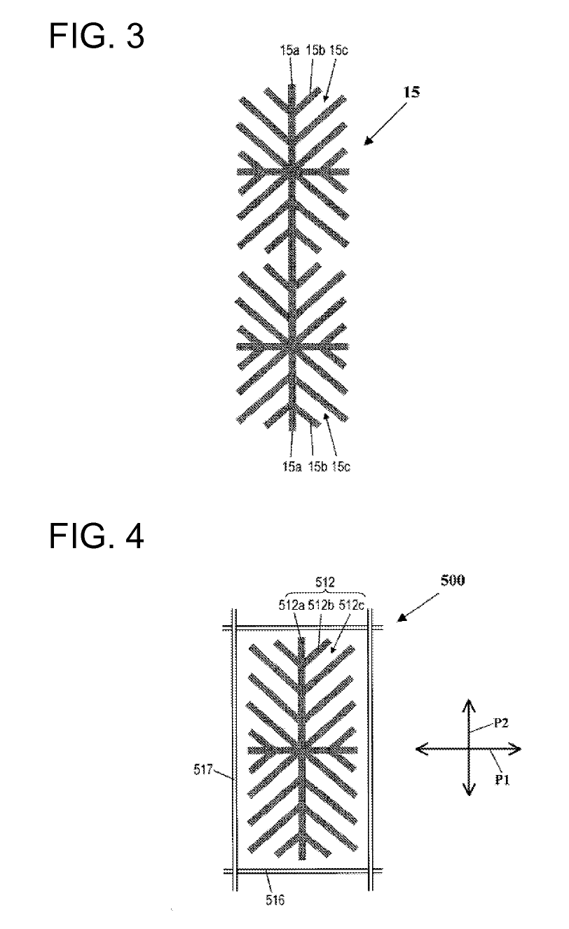

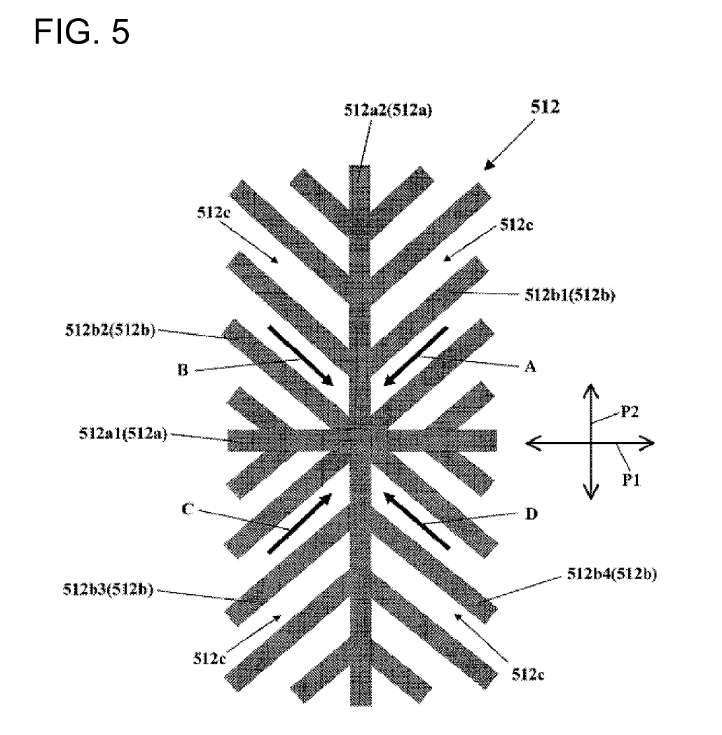

Note that the present embodiment exemplifies a case in which a single 4D structure is formed in a single pixel, but if a plurality of structures such as the one shown in FIG. 2 are formed within a single pixel, a plurality of 4D structures can be formed within a single pixel. For instance, if the upper-layer conductive layer 15 has two cross-shaped trunk portions 15a as shown in FIG. 3, two 4D structures are formed within a single pixel. Thus, it is acceptable if the upper-layer conductive layer 15 of the pixel electrode 12 contains at least one cross-shaped trunk portion 15a.

### INDUSTRIAL APPLICABILITY

The present invention is suitably used for a multi-domain-type liquid crystal display device including a vertically aligned liquid crystal layer. The liquid crystal display device according to the present invention is suitably used as the display portion of various electronic devices such as mobile phones, PDAs, notebook PCs, monitors, and television receivers.

### DESCRIPTION OF REFERENCE CHARACTERS

1 active matrix substrate (TFT substrate)
2 opposite substrate (color filter substrate)
12 pixel electrode
13 lower-layer conductive layer (lower-layer electrode)
14 dielectric layer (insulating film)
15 upper-layer conductive layer (upper-layer electrode)
15a trunk portion
15b, 15b1, 15b2, 15b3, 15b4 branch portion
15c slit
16 scan wiring
17 signal wiring
22 opposite electrode
32a, 32b vertical alignment film
34a, 34b alignment sustaining layer
40 liquid crystal layer
41 liquid crystal molecule
50a, 50b polarizing plate
100 liquid crystal display device

1. A liquid crystal display device having a plurality of pixels and a pair of polarizing plates arranged in crossed Nicols for performing display in normally black mode, each of said plurality of pixels comprising:
a liquid crystal layer containing liquid crystal molecules having negative dielectric anisotropy;
a pixel electrode and an opposite electrode that face each other via said liquid crystal layer; and
a pair of vertical alignment films respectively provided between said pixel electrode and said liquid crystal layer and between said opposite electrode and said liquid crystal layer,
wherein said pixel electrode has a lower-layer conductive layer, a dielectric layer that covers said lower-layer conductive layer, and an upper-layer conductive layer provided on said dielectric layer on a side of said liquid crystal layer,
wherein said upper-layer conductive layer has a cross-shaped trunk portion arranged so as to overlap with the polarizing axes of said pair of polarizing plates, a plurality of branch portions that extend in substantially 45° directions from said trunk portion, and a plurality of slits formed between said plurality of branch portions, and
wherein said lower-layer conductive layer is provided so as to face at least said plurality of slits via said dielectric layer.

2. The liquid crystal display device according to claim 1, wherein said lower-layer conductive layer is electrically connected to said upper-layer conductive layer.

3. The liquid crystal display device according to claim 1, wherein said lower-layer conductive layer is provided so as to face said trunk portion and said plurality of branch portions as well via said dielectric layer.

4. The liquid crystal display device according to claim 1, wherein when a voltage is applied across said pixel electrode and said opposite electrode, four liquid crystal domains are formed in said liquid crystal layer within each of said plurality of pixels,
wherein the orientations of the four directors representing the directions of alignment of said liquid crystal molecules that are contained in each of said four liquid crystal domains are different from each other, and
wherein each of the orientations of said four directors forms an angle of substantially 45° with respect to the polarizing axes of said pair of polarizing plates.

5. The liquid crystal display device according to claim 4, wherein said four liquid crystal domains are a first liquid crystal domain in which the orientation of the director is a first orientation, a second liquid crystal domain in which the orientation of the director is a second orientation, a third liquid crystal domain in which the orientation of the director is a third orientation, and a fourth liquid crystal domain in which the orientation of the director is a fourth orientation, with said first orientation, second orientation, third orientation, and fourth orientation being such that the difference in orientation between any two of the orientations is substantially equal to an integral multiple of 90°, and
wherein the orientations of the directors of liquid crystal domains that are adjacent to each other via said trunk portion differ by substantially 90°.

6. The liquid crystal display device according to claim 1, wherein this liquid crystal display device additionally has a pair of alignment sustaining layers made of a photopolymer and respectively formed on the surfaces of said pair of vertical alignment films on the side of said liquid crystal layer.
